(19) United States
(12) Patent Application Publication
(10) Pub. No.: US 2019/0005663 A1
(43) Pub. Date: Jan. 3, 2019

(54) METHOD FOR REDUCING IMPACT OF SURFACE TEXTURE IN AN OPTICAL SCAN AND DEVICES THEREOF

(71) Applicant: Adcole Corporation, Marlborough, MA (US)

(72) Inventors: Chase R. Olle, Allston, MA (US); James F. Munro, Ontario, NY (US)

(21) Appl. No.: 15/639,322

(22) Filed: Jun. 30, 2017

(51) Int. Cl. G06T 7/40; G01B 11/25; G06T 7/00; G06T 11/60

(52) U.S. Cl. CPC G06T 7/40; G06T 11/60; G06T 7/0004; G01B 11/2518

(57) ABSTRACT

Methods, non-transitory computer readable media, and content customization apparatuses that provide instructions to an optical scanner device, configured to be capable of producing a localization element on the surface of the test object, to scan the localization element to a plurality of points across the surface of the test object in a two-dimensional scan pattern. Image data of an image of the localization element at each of the plurality of points along the surface of the test object is obtained. The obtained image data is processed to determine a surface profile for the test object. The two-dimensional scan pattern reduces surface texture errors in the surface profile.

This technology generally relates to optical scanning devices and methods and, more particularly, to a method for reducing impact of surface texture in an optical scan and devices thereof.

### BACKGROUND

Nearly all manufactured objects need to be inspected after they are fabricated. A variety of optical devices have been developed for in-fab and post-fab inspection. Many of these optical devices scan the surface of the part and are able to measure the surface profile of the part with good accuracy. However, many manufactured objects that are to be inspected have surfaces that are rough, microstructured, or otherwise textured, and the surface features can influence the reflectance of the light reflected from the surface during the scanning and measurement process and consequently influence the accuracy of the measured surface profile.

The surface texture commonly encountered on the surfaces of the manufactured objects to be measured are often highly asymmetric and have a surface roughness width in a scan direction that is different than the surface roughness width in a direction that is orthogonal to the nominal scan direction of the scanner. Therefore, it is beneficial during the surface-measurement process to scan not only in one direction, but additionally in a direction that is orthogonal to the primary scan direction so the influences of surface texture on measurement accuracy are minimized.

### SUMMARY

A method for reducing impact of surface texture in an optical scan of a surface of a test object implemented by a scan management apparatus includes providing instructions to an optical scanner device, configured to be capable of producing a localization element on the surface of the test object, to scan the localization element to a plurality of points across the surface of the test object in a two-dimensional scan pattern. Image data of an image of the localization element at each of the plurality of points along the surface of the test object is obtained. The obtained image data is processed to determine a surface profile for the test object. The two-dimensional scan pattern reduces surface texture errors in the surface profile.

A scan management apparatus comprising memory comprising programmed instructions stored thereon and one or more processors configured to be capable of executing the stored programmed instructions to provide instructions to an optical scanner device, configured to be capable of producing a localization element on the surface of the test object, to scan the localization element to a plurality of points across the surface of the test object in a two-dimensional scan pattern. Image data of an image of the localization element at each of the plurality of points along the surface of the test object is obtained. The obtained image data is processed to determine a surface profile for the test object. The two-dimensional scan pattern reduces surface texture errors in the surface profile.

A non-transitory computer readable medium having stored thereon instructions for reducing impact of surface texture in an optical scan of a surface of a test object comprising executable code which when executed by one or more processors, causes the one or more processors to provide instructions to an optical scanner device, configured to be capable of producing a localization element on the surface of the test object, to scan the localization element to a plurality of points across the surface of the test object in a two-dimensional scan pattern. Image data of an image of the localization element at each of the plurality of points along the surface of the test object is obtained. The obtained image data is processed to determine a surface profile for the test object. The two-dimensional scan pattern reduces surface texture errors in the surface profile.

Accordingly, the present technology provides a method, computer readable medium, and scan management apparatus that advantageously cause an optical scanner device to scan a test object in a predetermined two-directional or two-axis scan pattern, such that the surface texture of the test object has minimal effect on the resulting surface profile measured by the optical scanner device. The two-axis scan pattern can be a triangular pattern, sawtooth pattern, square pattern, sinusoidal pattern, or even a random pattern.

### BRIEF DESCRIPTION OF THE DRAWINGS

FIG. 1 is a functional block diagram of an three-dimensional optical scanner system including a three-dimensional scanner device and a scan management apparatus;

FIG. 2 is a block diagram of an exemplary scan management apparatus;

FIG. 3 is a side view of a three-dimensional optical scanner device;

FIG. 4 is a plan view of the three-dimensional optical scanner device;

FIG. 5 is a side view of the three-dimensional optical scanner device showing the envelope of the light paths associated with the three-dimensional optical scanner device;

FIG. 6 is a flow chart of an exemplary method for reducing impact of surface texture in an optical scan of a surface of a test object;

FIG. 7 is an image of a cross-hair projected onto a planar object;

FIG. 8 is an image of the cross-hair projected onto a cylindrical object;

FIG. 9 is a point-wise measurement path of a linear scan profile across a planar object;

FIG. 10 is a point-wise measurement path of a linear scan profile across a cylindrical object;

FIG. 11A is a photomicrograph of a surface of an object having coarse machining marks;

FIG. 11B is an image of the cross-hair projected onto the surface of FIG. 11A at the plane of the image sensor;

FIG. 12 illustrates a point-wise measurement path of a sawtooth scan profile across a planar object;

FIG. 13 illustrates a point-wise measurement path of a sawtooth scan profile across a cylindrical object;

FIG. 14 illustrates a point-wise measurement path of a square scan profile across a planar object;

FIG. 15 illustrates a point-wise measurement path of a square scan profile across a cylindrical object;

FIG. 16 illustrates a point-wise measurement path of a triangle scan profile across a planar object;

FIG. 17 illustrates a point-wise measurement path of a triangle scan profile across a cylindrical object;

FIG. 18 illustrates a point-wise measurement path of a sinusoidal scan profile across a planar object;

FIG. 19 illustrates a point-wise measurement path of a sinusoidal scan profile across a cylindrical object;

FIG. 20 illustrates a point-wise measurement path of a random scan profile across a planar object;

FIG. 21 illustrates a point-wise measurement path of a random scan profile across a cylindrical object;

### DETAILED DESCRIPTION

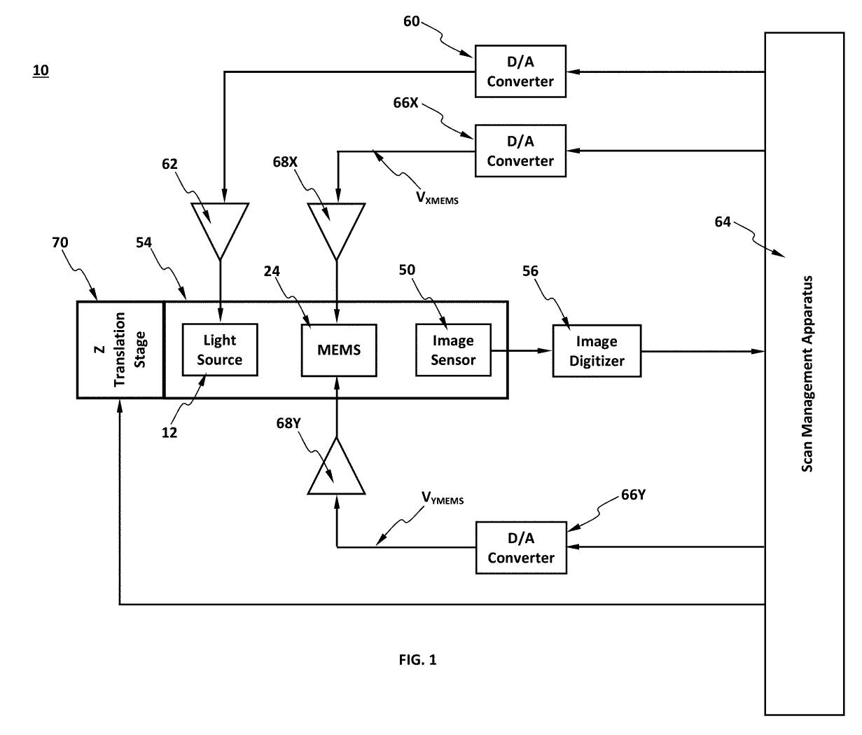

Referring to FIG. 1, an exemplary optical scanning system 10 with an exemplary scan management apparatus 64 is illustrated. The scan management apparatus 64 in this example is coupled to a optical scanner device 54 including a source arm and an imaging arm. In this example, the scan management apparatus 64 is coupled to the optical scanner device 54 through an image digitizer 56, digital-to-analog (D/A) converters 60, 66X, and 66Y, a light source driver 62, a MEMS (Micro Electro-Mechanical System) X-channel driver 68X, and MEMS Y-channel driver 68Y, and a Z-translational stage 70, although the exemplary optical scanning system 10 may include other types and numbers of devices or components in other configurations. This technology provides a number of advantages including methods, non-transitory computer readable media, and calibration management apparatuses that facilitate more efficient calibration of a three-dimensional optical scanner device without the use of a feedback loop.

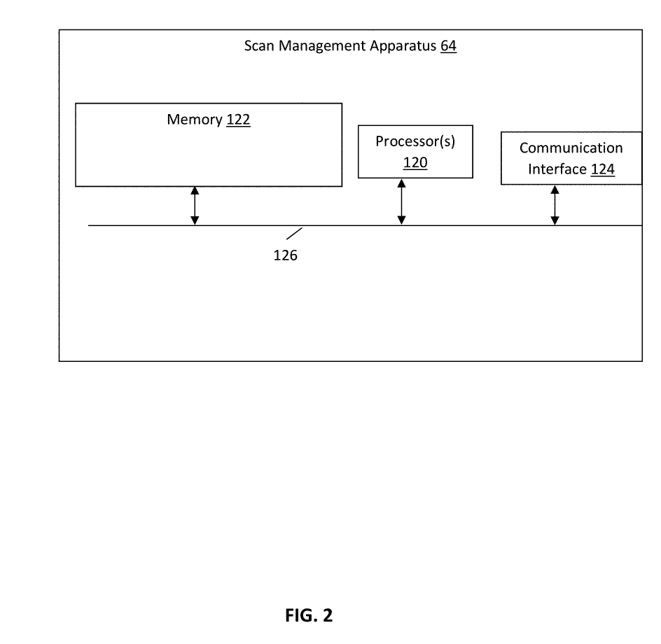

Referring now to FIGS. 1 and 2, the scan management apparatus 64 in this example includes one or more processors 120, a memory 122, and/or a communication interface 124, which are coupled together by a bus 126 or other communication link, although the scan management apparatus 64 can include other types and/or numbers of elements in other configurations. The processor(s) 120 of the scan management apparatus 64 may execute programmed instructions stored in the memory 122 for the any number of the functions described and illustrated herein. The processor(s) 120 of the scan management apparatus 64 may include one or more CPUs or general purpose processors with one or more processing cores, for example, although other types of processor(s) can also be used.

The memory 122 of the scan management apparatus 64 stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s) 120, can be used for the memory 122.

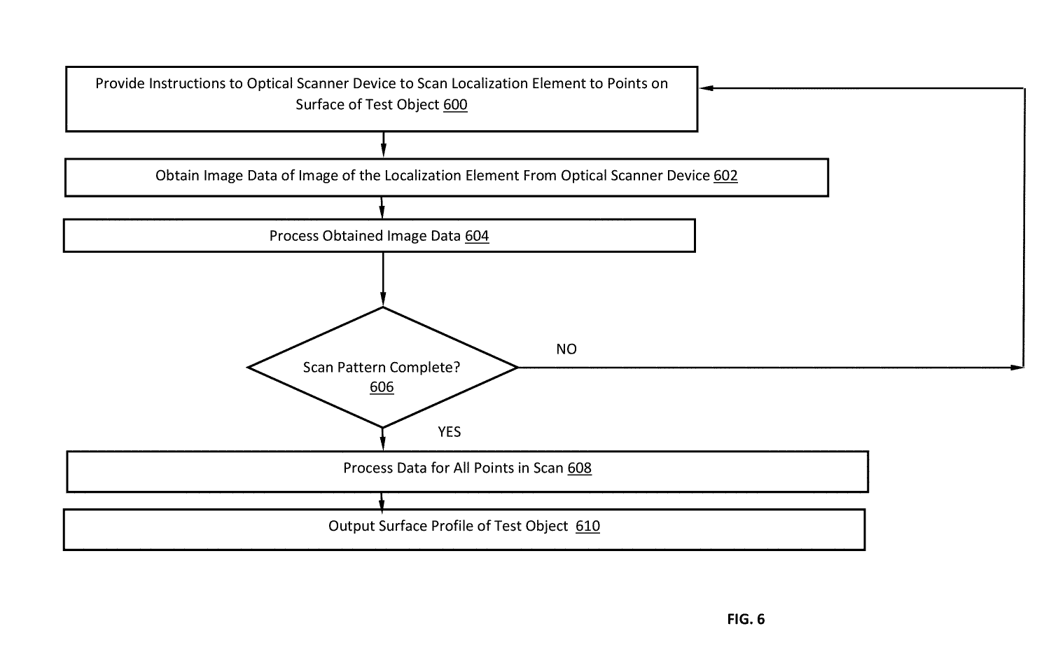

Accordingly, the memory 122 of the scan management apparatus 64 can store one or more applications or programs that can include computer executable instructions that, when executed by the scan management apparatus 64, cause the scan management apparatus 64 to perform actions described and illustrated below with reference to FIGS. 6 and 12-21. The application(s) can be implemented as modules or components of other applications. Further, the application(s) can be implemented as operating system extensions, module, plugins, or the like.

Even further, the application(s) may be operative in a cloud-based computing environment. The application(s) can be executed within or as virtual machine(s) or virtual server(s) that may be managed in a cloud-based computing environment. Also, the application(s) may be running in one or more virtual machines (VMs) executing on the scan management apparatus 64.

The communication interface 124 of the scan management apparatus 64 operatively couples and communicates between the scan management apparatus 64 and the image digitizer 56, the digital-to-analog (D/A) converters 60, 66X, and 66Y, the light source driver 62, the MEMS X-channel driver 68X, and the MEMS Y-channel driver 68Y as known in the art. In another example, the scan management apparatus 64 is a highly integrated microcontroller device with a variety of on-board hardware functions, such as analog to digital converters, digital to analog converters, serial buses, general purpose I/O pins, RAM, and ROM.

Although the exemplary scan management apparatus 64 is described and illustrated herein, other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

In addition, two or more computing systems or devices can be substituted for the scan management apparatus 64. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

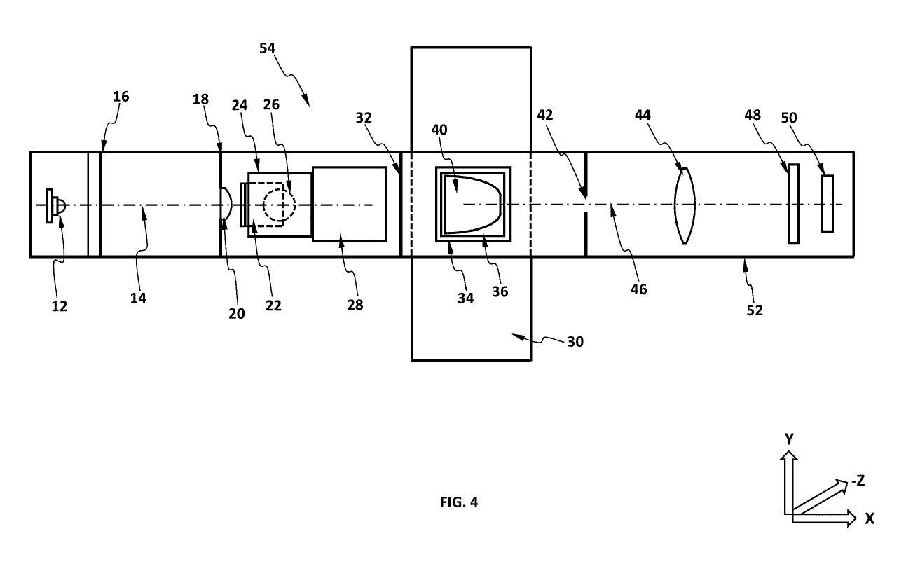

Referring now to FIGS. 1 and 3-5, an example of the optical scanner device 54 and its operation are illustrated. The present technology is applicable to nearly any three-dimensional optical scanner. An exemplary scanner assembly device that may be utilized with the present technology is disclosed in U.S. patent application Ser. No. 15/012,361, the disclosure of which is incorporated herein by reference in its entirety. In this example, the scanner assembly includes a light source 12, a reticle 16, a source baffle 18, a projection lens 20, a right angle prism lens 22, a MEMS 24, a MEMS mirror 26, a source window 28, an imaging window 34, a first lens element 36, a fold mirror 40, an aperture stop 42, a second lens element 44, an optical filter 48, an image sensor 50, in a cylindrical housing 52, although the optical scanner device 54 may include other types and/or numbers of other devices or components in other configurations.

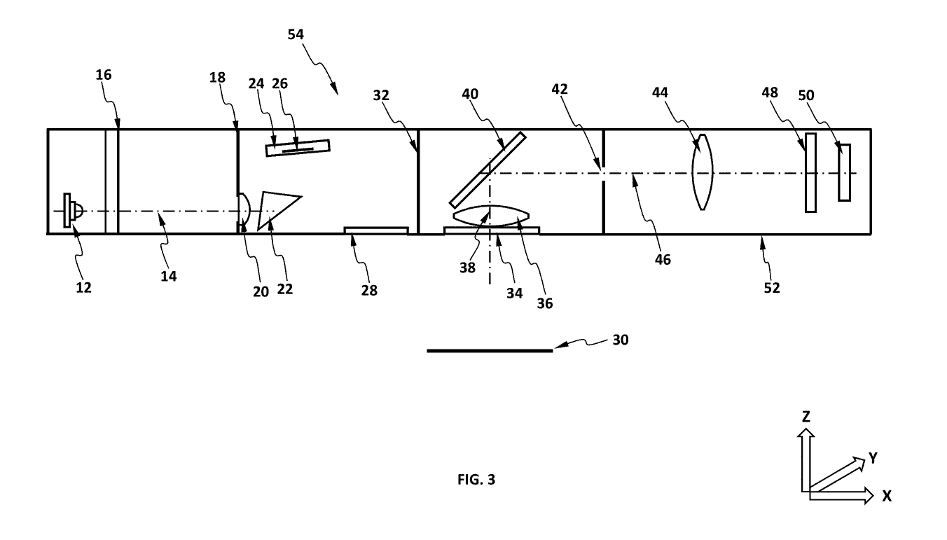

Referring now to FIGS. 3-5, the optical scanner device 54, whose housing 52 is cylindrically shaped and contains a source arm and an imaging arm. The source arm of the optical scanner device 54 includes the light source 12, such as an LED, nominally centered on a light source axis 14 whose source light 13 is incident on the reticle 16. The reticle 16 is substantially opaque with the exception of a transparent aperture that is also nominally centered on the light source axis 14, and orthogonal to it. The transparent aperture of the reticle 16 can have a circular shape, or instead have a pattern such as a cross-hair pattern, that transmits through it any of the source light 13 incident upon it. The reticle light 15 is that portion of the source light 13 that passes through the reticle 16, and the reticle light 15 is in turn incident on the source baffle 18, which also has an aperture. The projection lens 20 is positioned in the aperture of the source baffle 18. The reticle light 15, whose envelope is generally divergent, that is incident on the projection lens 20 is transmitted through the projection lens 20 and exits as projection lens light 21 whose envelope is generally converging.

The projection lens light 21 then enters a short side of the right angle prism 22, is reflected from the hypotenuse of the right angle prism 22, and then exits through the second short side of the right angle prism 22 as prism light 23. The prism light 23 is then incident on the MEMS mirror 26 of the MEMS 24, and is reflected from the MEMS mirror 24 into projected light 27 in accordance with the law of reflection. The projected light 27 then passes through the source window 28 and comes to a focus on a test object 30. The projected light image 31 is an image of the aperture of the reticle 16. In this example, the aperture of the reticle 16 has the shape of a cross-hair such that the image produced by the projected light 27 on the test object 30 also has a cross-hair shape, which provides a localization element on the surface of the test object 30. A cross-hair shaped reticle aperture and a cross-hair shaped projected light image 31, or localization element, will be assumed for the balance of this disclosure, although other aperture and image shapes are possible, such as round, cross-hatched, etc.

Referring again to FIGS. 3 through 5, it is shown that a portion of the projected light 27 incident on the test object 30 is reflected as reflected image light 33, a portion of which passes through the imaging window 34 and the first lens element 36. The first lens element 36 causes the diverging reflected image light 33 incident upon it to exit as converging first lens element light 37, which then reflects from the fold mirror 40, and a portion of which passes through the aperture stop 42 as apertured light 43.

The apertured light 43 is then incident on the second lens element 44 which causes the apertured light 43 to come to a focus at image 51 on the image sensor 50 after passing through the optical filter 48. The image 51 is an image of the projected light image 31, and is cross-hair shaped if the projected light image 31 is also cross-hair shaped. The image 51 is an image of a cross-haired shaped localization element on the surface of the test object, although other shapes may be employed for the localization element. The first lens element 36 acts cooperatively with the aperture stop 42 and the second lens element 44 to form a telecentric lens in which the magnification of the imaging system does not change substantially with changes in the distance between the test object 30 (i.e., the elevation of the projected light image 31) and the imaging window 34 (i.e., the elevation of the optical scanner device 54).

Referring again to FIG. 1, the electro-mechanical coupling between the scan management apparatus 64 and the optical scanner device 54 of the present technology will now be described. As seen in FIG. 1, the central scan management apparatus 64 is used to control the electro-mechanical functional blocks controlling the optical scanner device 54. In particular, one digital output of the scan management apparatus 64 is coupled to an input of the D/A (digital-to-analog) converter 60 whose output is coupled to an input of the light source driver 62 whose output is then coupled to the light source 12 within the optical scanner device 54. In this way the scan management apparatus 64 can control the amount of light emitted by the light source 12.

Similarly, another digital output of the scan management apparatus 64 is coupled to an input of the D/A converter 66X whose output is coupled to an input of the MEMS X-channel driver 68X whose output is then coupled to a first input of the MEMS 24 within the optical scanner device 54. In this way, the scan management apparatus 64 can control the angular tilt of the MEMS mirror 26 about the X-axis. Additionally, another digital output of the scan management apparatus 64 is coupled to an input of the D/A converter 66Y whose output is coupled to an input of the MEMS Y-channel driver 68Y whose output is then coupled to a second input of the MEMS 24 within the optical scanner device 54. In this way, the scan management apparatus 64 can control the angular tilt of the MEMS mirror 26 about the Y-axis. MEMS mirror 26 of MEMS 24, together with controlling electronics MEMS X-channel driver 68X and MEMS Y-channel driver 68Y, form a scan mechanism that can cause the projected light 27 to be scanned across the surface of a test object 30. This scanning can be a smooth continuous scan in which the projected light image 31 moves at a substantially constant velocity across the test object, or it can consist of a series of discrete points in which the scanning velocity is fast between points and then the scanning momentarily stops for a dwell time at each scan point so the cross-hair can be imaged and processed by the scan management apparatus 64. The balance of this disclosure will assume that the scanning process is point-wise in nature.

Yet another digital output of scan management apparatus 64 is coupled to the Z-translation stage 70, which is used to raise or lower the test object 30 (or alternately raise or lower the optical scanner device 54), so the distance between the test object 30 and the optical scanner device 54 can be varied under the control of the scan management apparatus 64. This distance needs to be varied, for example, to optimize the quality of the focus of the projected light image 31 at the test object 30.

Continuing to refer to FIG. 1, it is seen that the output of the image sensor 50 within the optical scanner device 54 is coupled to an input of the image digitizer 56 which samples the video signal output by the image sensor 50 and converts it to a digital representation of the image 51 produced on the input face of the image sensor 50. The digital representation of the image created by the image digitizer 56 is then output to a digital input of the scan management apparatus 64 so that the scan management apparatus 64 can access and process the images produced by the optical scanner device 54.

An exemplary method of reducing impact of surface texture in an optical scan of a surface of a test object will now be described with reference to FIGS. 1-21. At step 600 of FIG. 6, the scan management apparatus 64 provides instructions to the optical scanner device 54 to scan the cross-hair image, or localization element, provided by the projected light from the light source 12 to a plurality of points across the surface of the test object 30 in a two-dimensional scan pattern.

In one example, providing the instructions for executing the pointwise scan includes the scan management apparatus 64 providing instructions to D/A converter 66X that cause D/A converter 66X to output an analog voltage that is input to the MEMS X-channel driver 68X whose output causes the MEMS mirror 26 to move to the desired angular position about the X-axis. The scan management apparatus 64 also provides instructions to D/A converter 66Y that cause D/A converter 66Y to output an analog voltage that is input to the MEMS Y-channel driver 68Y whose output causes the MEMS mirror 26 to move to the desired angular position about the Y-axis. The scan management apparatus 64 further provides instructions to D/A converter 60 that cause D/A converter 60 to output an analog voltage that is input to the light source driver 62 whose output causes the light source 12 to emit light such that a cross-hair, or localization element, is projected onto the test object 30 at the location of the projected light image 31. The present technology utilizes a two-dimensional scan pattern as discussed in further detail below, which advantageously reduces surface texture errors in the obtained surface profile of the test object 30. The two-dimensional scan pattern may be a sawtooth pattern, a square pattern, a sinusoidal pattern, a pseudo-random pattern, or combinations thereof. In another example, the scan pattern may have one or more of the aforementioned patterns superimposed on one another.

Next, at step 602, the scan management apparatus 64 obtains image data of the image of the localization element, such as the cross-hair provided by the optical scanner device 54 for each of the points along the surface of the test object 30 that are a part of the point-wise scan. A portion of the light of the projected light image 31 reflected by the test object 30 is imaged by the telecentric lens which produces an image 51 on the image sensor 50. The image sensor 50 outputs an analog electronic representation of the image 51 which is digitized by image digitizer 56, which outputs a digital representation of the image 51 to an input of the scan management apparatus 64. Scan management apparatus 64 has programming which analyzes the digital representation of image 51 and executes a localization algorithm and a triangulation algorithm that determines the precise spatial coordinates of the crossing point of the cross-hair, or localization element, of the projected light image 31 on the test object 30.

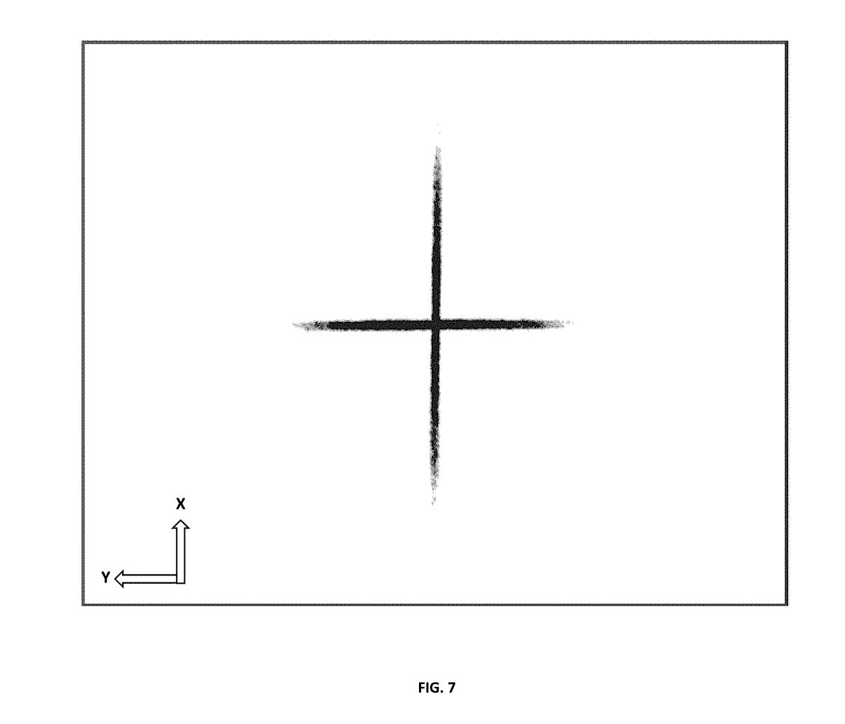

FIG. 7 shows an actual raw (i.e., unprocessed) image 51 of the cross-hair on a planar test object 30 as it appears at the image sensor 50. The planar test object 30 that the cross-hair is projected onto in FIG. 7 has a mild uniform homogeneous (and not asymmetric) texture that evenly diffuses the reflected cross-hair image light 33 such that the amount and direction of reflected image light 33 is not a function of position along the surface of the planar test object 30. Consequently, the image 51 of the cross-hair in FIG. 7 is largely free from “artifact noise” or biases, although some electronic noise from the image sensor 50 is evident at the tips of the arms of the cross-hair.

Note the directions of the X-axis and Y-axis on the test object 30 (the axes key in the lower left corner of the image in FIG. 7 is for reference and is not part of the actual image, which is the case for all the following images in subsequent figures as well), and the primary scan direction is in the left-right direction (i.e., parallel to the Y-axis), and the cross-scan direction is in the up-down direction (i.e., parallel to the X-axis), which is the case for all the following images in subsequent figures as well.

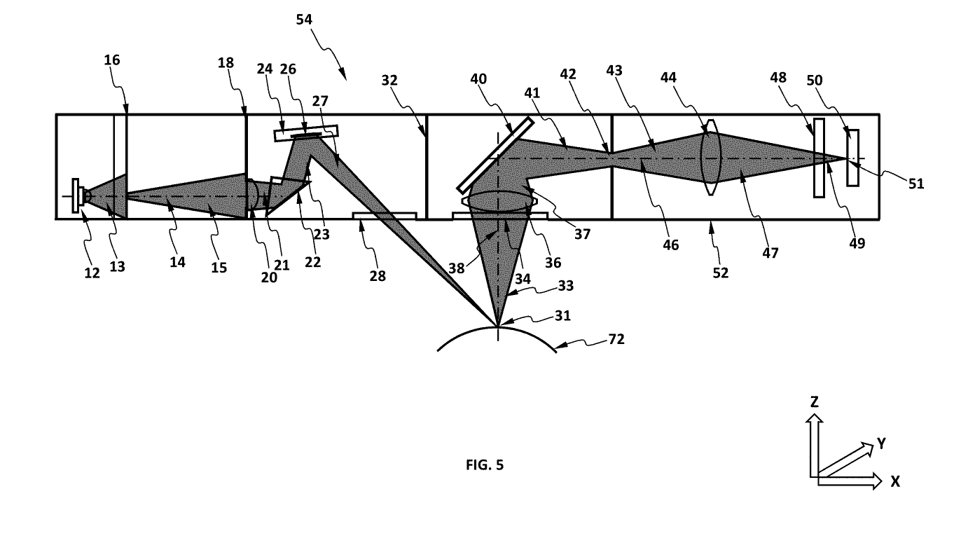

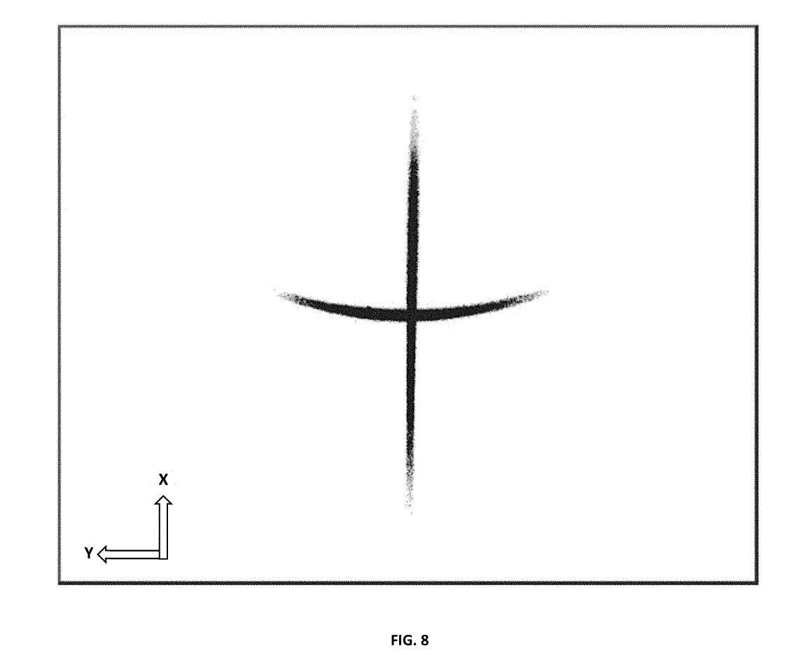

FIG. 8 is an image 51 present at the input face of the image sensor 50 of a cross-hair projected onto a lightly textured cylindrically-shaped test object 30 having a radius of 3 mm, at a single point of a scan, in which the axis of the cylindrical test object 30 is substantially parallel to the X-axis (by contrast, FIG. 5 shows a cylindrical test object 72 whose axis is substantially parallel to the Y-axis). Note that the vertical arms (those substantially parallel to the X-axis) of the cross-hair are still linearly shaped whereas the side-to-side hair of the cross-hair is arcuate. This arcuate-shaped side-to-side hair of the cross-hair is due solely to the cylindrical shape of the test object 30 resulting from the oblique projection angle of the projected light 27 onto the test object 30.

At step 604 of the flowchart of FIG. 6, the scan management apparatus 64 processes the image data obtained in step 602 to determine a surface profile for the test object 30. The image processing function performed by the scan management apparatus 64 is principally to find the precise location, in pixels or millimeters, of where the two hairs of the cross-hair image, or localization element, 51 cross. This processing, also known as localizing the cross-hair's position, is performed by identifying which pixels of the cross-hair belong to the vertical (i.e., in the X-direction) arms, and fitting a line to those pixels, then identifying which pixels of the cross-hair belong to the side-to-side arms, and fitting a line (or a parabola, or ellipse, depending on the contour of the test object 30) to those pixels, and then algebraically finding the intersection point of the two lines which is the result of the localizing process. Note that the localization process is executed for each scan point of a scan, so that the location of the cross-hair, or localization element, is known for each point of the scan, from which the contour of the surface being scanned can be determined. While the contour of the surface can generally have any continuous (i.e., not having discontinuities, or steps or undercuts) shape, many surfaces of interest have a cylindrical shape. Indeed, for the purposes of this disclosure, a test object 30 that is non-planar will be assumed to be cylindrical, and the radius of the cylinder will be a key measurement parameter determined by the three-dimensional optical scanner system 10. This crossing point computed in step 604 is then stored in the memory 122.

In step 606, the scan management apparatus 64 determines whether the scan pattern, as described in further detail below is complete. If in step 606 the scan is determined to be incomplete, the No branch is taken back to step 600 and the scan management apparatus 64 then commands the MEMS mirror 26 to the next angular orientation in accordance with the next desired scan location by way of providing instructions to D/A converter 66Y and (optionally) 66X as described previously. When the MEMS mirror 26 consequently moves to the next position, the projected light image 31 also moves to the next scan point or scan location on the test object 30, and a new image 51 (having a different crossing-point location) is formed by the telecentric lens on the input face of the image sensor 50.

Once again the scan management apparatus 64 receives a digital representation of the cross-hair, or localization element, image from image digitizer 56, and executes localization and triangulation algorithms to determine the precise spatial coordinates of the crossing point of the cross-hair, or localization element, of the projected light image 31 on the test object 30. These coordinates are also stored in the memory 122 of the scan management apparatus 64.

The scan management apparatus 64 then executes several more cycles of MEMS mirror 26 motion and cross-hair processing in accordance with the number and positions of the scan points across the test object 30, each time storing the computed coordinates of the projected light image 31 in the memory 122.

When, in step 606, the scan management apparatus determines that all of the points of the scan have been executed and processed, i.e., the scan is complete and all of the coordinates of the projected light image 31 for every scan point have been stored in the memory 122, the Yes branch is taken to step 608 where the scan management apparatus 64 can process the scan points as directed by the operator of the three-dimensional light scanner system 10. In one example, the saved coordinates are processed by fitting a circle to the coordinates, in which the radius of the circle as well as the coordinates of the center of the circle, are computed. In step 610, the final data for the scan is output to provide a profile for the surface of the test object 30 by way of example.

In order to measure the radius of a test object 30 such as the cylindrical object of FIG. 8, the cross-hair is caused to scan (as described above) across the surface of the cylindrical test object 30. This measurement scan includes a series of N (N being an integer) discrete measurement points along the primary scan axis or direction in which the (X, Y) crossing-point of the arms of the cross-hair is localized to sub-pixel resolution at each of the N measurement points, and then, by use of a triangulation algorithm the (Y, Z) coordinates for each of the N measurement points are also computed. Next, the series of N (Y, Z) measurement points are fit to a circle by the scan management apparatus 64, and the radius of that circle is the measured radius of the cylindrical test object 30. Note that the value of N can be between three and 1000, and the degrees of measurement arc can between 0.5 degrees to 180 degrees, with 45 degrees being the minimum angular arc length generally necessary for accurate radius results.

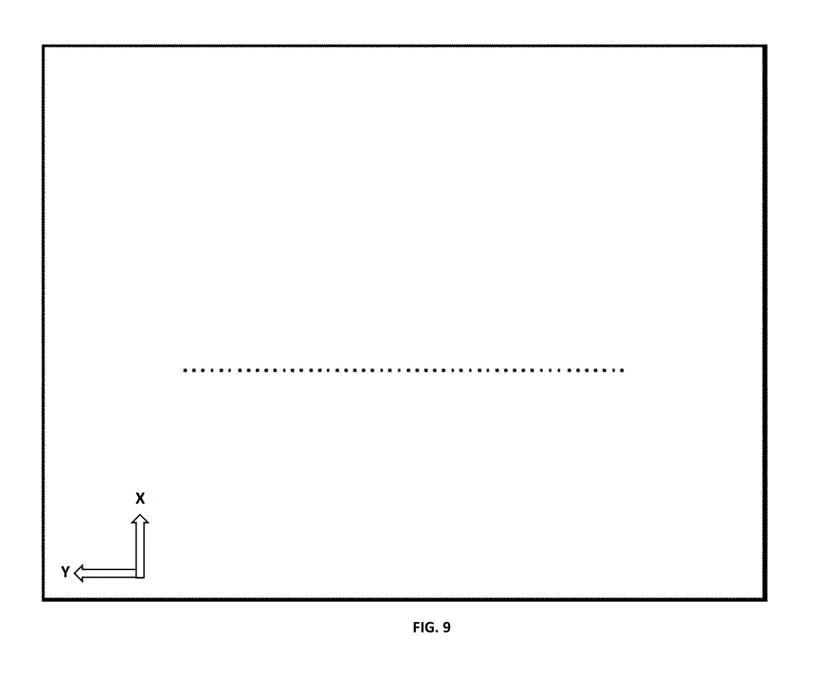

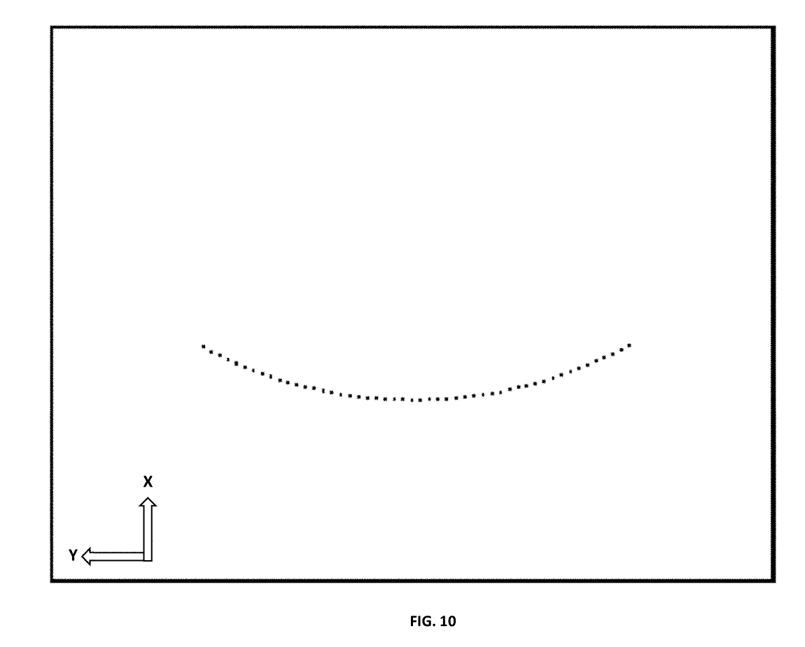

As set forth above, the present technology employs a two-dimensional scan pattern to reduce the impact of surface texture in the scan. The impact of surface texture on a one-dimensional scan will now be described with respect to FIGS. 9-11. FIG. 9 illustrates a series of N=50 measurement points of a single axis (in the primary scan direction or Y-axis) scan as a series of 50 dots for a planar test object 30 in which each dot represents the computed localized (X, Y) crossing-point of the hairs of the cross-hair. Similarly, FIG. 10 shows the series of N=50 scan and localized points of a single axis scan in the primary scan axis in which the test object 30 is a cylinder or a portion of a cylinder, having its axis substantially parallel to the X-axis. The two-dimensional arc shape of the scan profile in this case is due solely to the cylindrical shape of the test object 30 resulting from the oblique projection angle of the projected light 27 onto the test object 30, and is not due to any scanning of the projected light in the X-axis.

The vast majority of test objects 30 whose surface is to be measured or profiled have residual, and generally undesirable, surface micro-features imparted by the fabrication process. By way of example, the techniques of the present technology may be utilized to obtain surface profile measurements for objects such as camshafts or crankshafts, although any test object having surface micro-features may be measured using the present technology. These microscopic (and non-microscopic in some cases) surface features are characterized by a roughness number, which generally is a characterization of the size, width, or length of the microscopic surface features, in micrometers. For example, a milled surface typically has surface features from 0.5 μm to 5.0 μm in size, while a polished surface typically has surface features from 0.25 μm to 0.05 μm in size.

In an optical measurement system 10 including optical scanner device 54 such as that described above in connection to FIG. 1 through FIG. 5, the characteristics of the reflected image light 33 are a strong function of the surface roughness of the test object 30. If the surface features present on the surface of a part being measured are stochastic or random (i.e., substantially non-periodic and not asymmetric in extent), and the surface features are much less than the width of a hair of the cross-hair projected onto the test object 30, then the cross-hair reflected image light 33 reflected from the test object 30 will not have any biases that influence the fidelity or location of the image 51 of the cross-hair on the image sensor 50, and the cross-hair localizing algorithm executed by the scan management apparatus 64 will yield an accurate cross-hair location result. However, if the surface features present on the surface of the test object 30 are not stochastic or not random (and perhaps are periodic and asymmetric in extent), then the cross-hair reflected image light 33 reflected from the test object 30 will in all likelihood have biases that influence the fidelity or location of the image 51 of the cross-hair on the image sensor 50, and the cross-hair localizing algorithm executed by the scan management apparatus 64 will yield an inaccurate cross-hair location result.

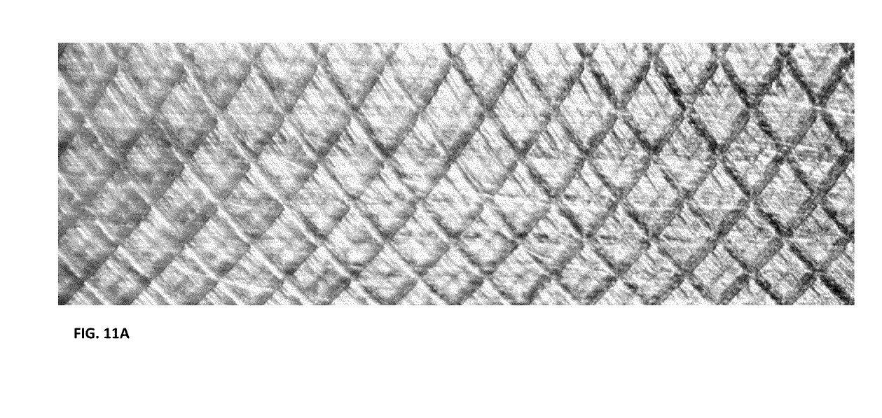

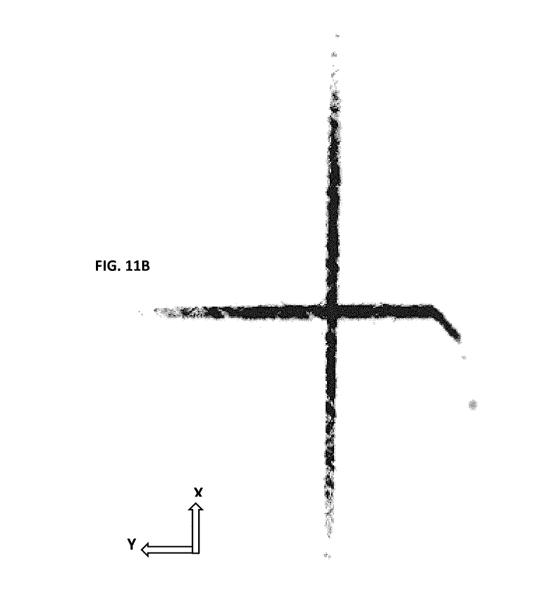

An extreme example of this is illustrated by the surface presented in FIG. 11A, which is an image of the surface of a substantially planar test object 30 that has been end-milled in which coarse (100 μm) machining marks are clearly visible in the surface. This surface is not stochastic or random because the surface features are periodic, and since the tooling marks are long and thin the features are asymmetric. Furthermore, the width of the tooling marks is approximately the same as the width of the arms of the cross-hair, which is about 80 μm in this example. The effects of the surface shown in FIG. 11A upon the cross-hair image 51 seen at the image sensor 50 is substantial and dramatic, as shown in FIG. 11B. The cross-hair image of FIG. 11B resulting from the reflectance of the cross-hair projected light image 31 from the test object 30 having the surface of that in FIG. 11A, has been corrupted as seen by the bend in the right arm of the cross-hair, which will aggravate the cross-hair localization algorithm and cause it to compute inaccurate cross-hair location results.

Furthermore, upon inspecting the remaining appearingly-straight arms of the cross-hair, it is seen that the light within the arms is not uniform and has voids and bright spots in accordance with the nonrandom, periodic, and asymmetric surface features apparent in FIG. 11A. While not qualitatively apparent from the cross-hair image of FIG. 11B that these voids and bright-spots can cause cross-hair localization computation errors, quantitatively it has been determined that they can indeed introduce cross-hair localization problems of several microns leading to cylinder radius calculation errors up to a few tens of microns.

An additional problem is that as a scan is undertaken and several scan-point locations are determined in sequence by use of the localization algorithm, the periodic nature of the surface roughness can “beat” against the pointwise scan process, and impart a pattern into the cross-hair locations such that the resulting computed surface topography is not representative of the topography of the actual surface. In other words, microscopic surface features can induce erroneous macroscopic surface features to be created during the measurement process.

Furthermore, the “beating” of a periodic surface microstructure against the pointwise scan pattern is not the only condition that can cause errors to occur in the surface measurement. It turns out that any non-random surface texture can cause measurement errors. For example, it has been determined that a surface having aperiodic tooling marks that are long (over 100 μm) and thin (less than 5 μm) can still cause biases in the reflected image light 33, and cause errors in the localization algorithm that can result in tens of microns of error in the computed radius of a cylindrical test object 30.

Scanning in just one direction during a measurement scan, as illustrated in FIG. 9 and FIG. 10, makes the surface measurement susceptible to errors caused by periodic surface microstructures and non-random asymmetric surface microstructures as discussed above. By changing the scan pattern to be two-dimensional, as described below, scan points can be taken that reside outside the envelope of the asymmetric surface microstructures in a second axis, or, in the case of a periodic surface microstructure, interrupt and ideally randomize the beat pattern so that its associated localization errors cancel or average to zero. Indeed, experiments have shown that scanning a certain distance into a second axis as part of a cylinder radius measurement can improve the radius measurement by a factor of three over a single axis scan along the primary scan direction.

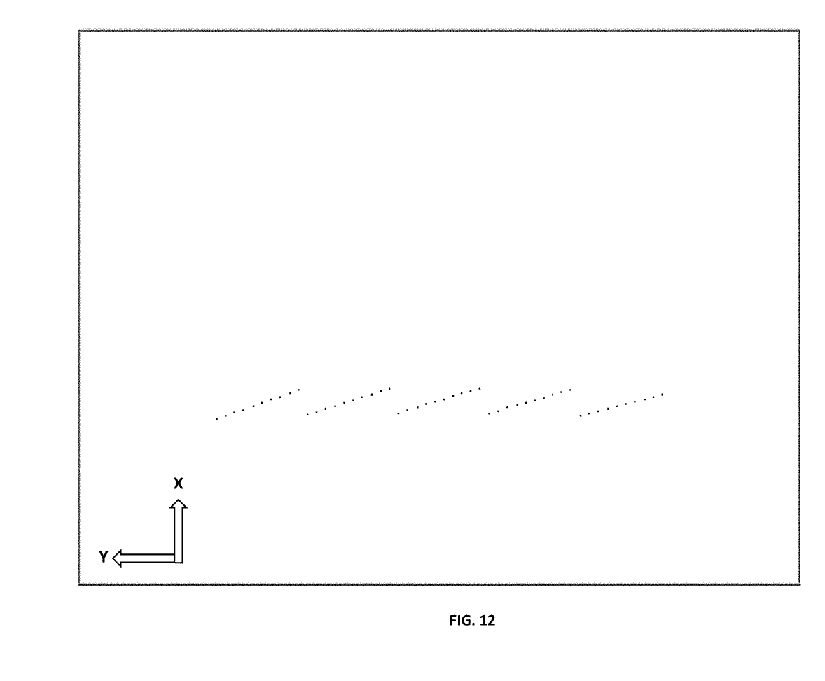

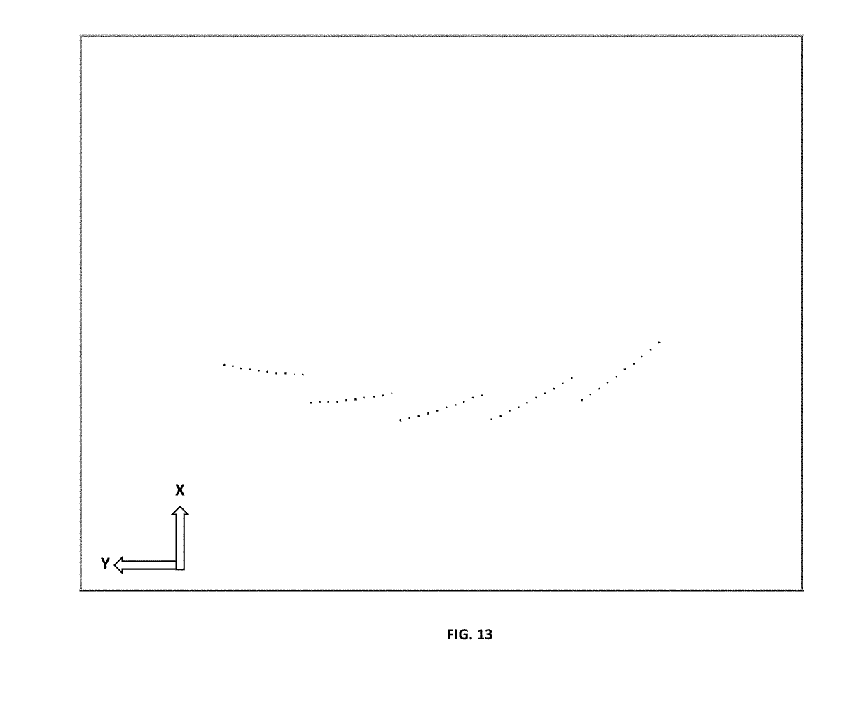

Several pointwise measurement scan patterns that provide for scanning into a second direction as part of the scan along the primary scan axis in accordance with the method described in FIG. 6 will now be described. One such pattern is a sawtooth scan pattern as illustrated in FIG. 12 and FIG. 13. In FIG. 12, the sawtooth scan pattern is made across a planar test object 30, while in FIG. 13 the sawtooth scan pattern is executed across the same cylindrical test object 30 used in the linear scan pattern of FIG. 10. A sawtooth scan pattern has a substantially piecewise linear scan profile in which several cycles of a linear scan (in both scan axes) are made to occur over the length of the scan, and in which each of the linear scans are substantially parallel with one another. In this example, there can be up to 1000 total scan points, between 2 and 500 cycles of the linear scan, and between 2 and 500 scan points per cycle. The distance between the scan points within a cycle along the secondary scan axis (the X-axis as shown in FIG. 12 and FIG. 13) at the surface of the test object 30 can be between 1.0 μm and 1.0 mm. Note that each of the cycles of the sawtooth scan profile illustrated in FIG. 13 appear to be arcuate and non-linear, which is caused solely by the cylindrical shape of the test object 30 and not by virtue of the scan mechanism scanning in a non-linear profile.

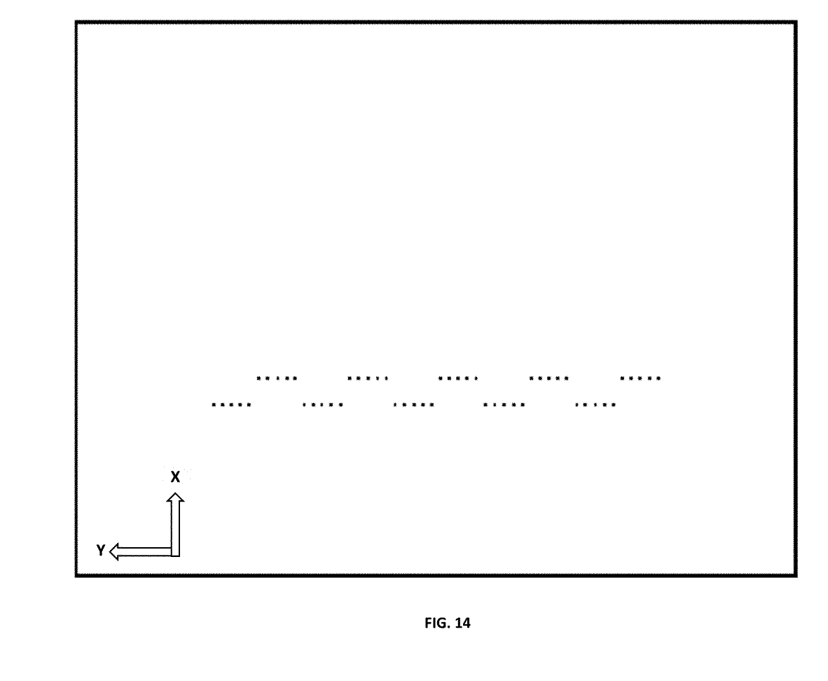

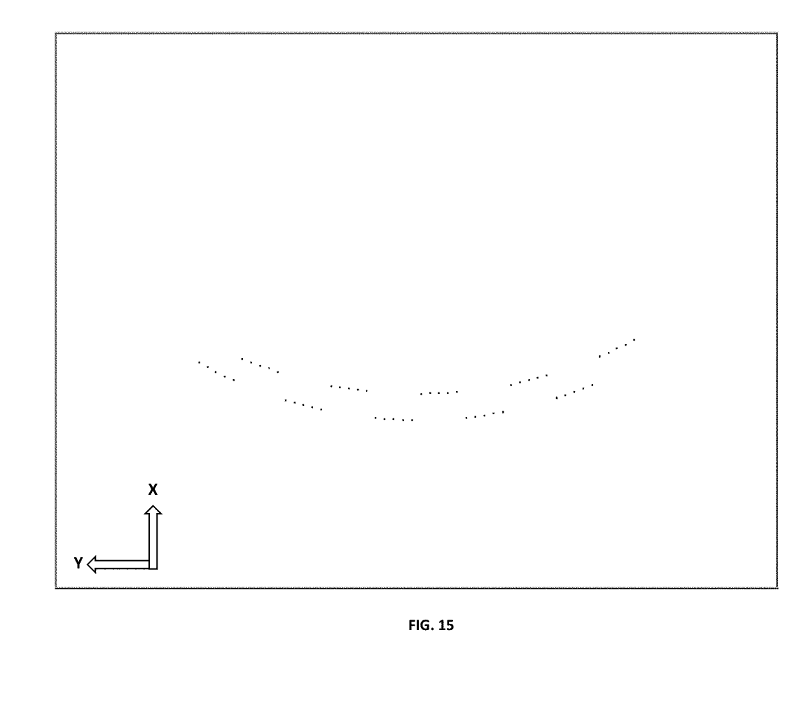

Another pattern that may be utilized in the present technology is a square scan pattern as illustrated in FIG. 14 and FIG. 15. In FIG. 14, the square scan pattern is executed across a planar test object 30, while in FIG. 15 the square scan pattern is made across the same cylindrical test object 30 used in the linear scan pattern of FIG. 10. A square scan pattern is essentially two interleaved linear scans that result in alternating linear segments in which each of the linear scan segments is in the primary scan direction and substantially parallel to the Y-axis. One cycle includes one pair of offset linear scans. In this example, there can be up to 1000 total scan points, between 2 and 500 cycles, and between 2 and 500 scan points per cycle. The distance between the offset linear scans within a cycle along the secondary scan axis (the X-axis as shown in FIG. 14 and FIG. 15) at the surface of the test object 30 can be between 5.0 μm and 5.0 mm. Note that each of the cycles of the square scan profile illustrated in FIG. 15 appear to be arcuate and non-linear, which is caused solely by the cylindrical shape of the test object 30 and not by virtue of the scan mechanism scanning in a non-linear profile.

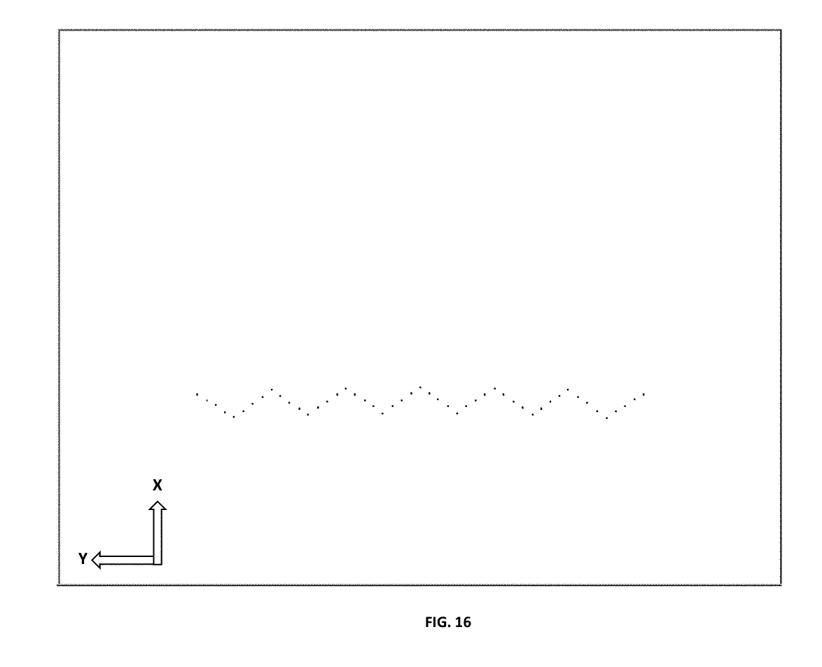

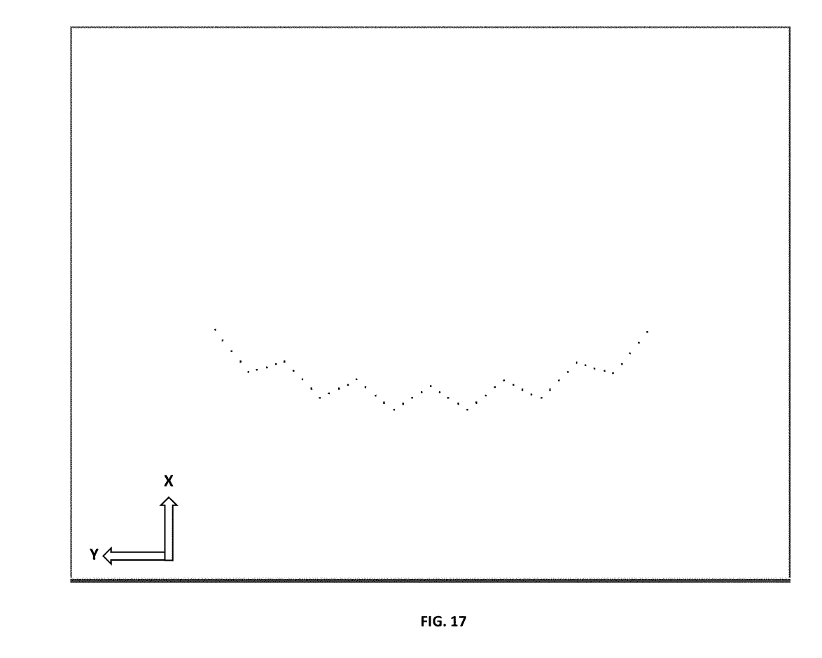

Yet another pattern that may be employed in the present technology is a triangular scan pattern as illustrated in FIG. 16 and FIG. 17. In FIG. 16, the triangular scan pattern is executed across a planar test object 30, while in FIG. 15 the triangular scan pattern is made across the same cylindrical test object 30 used in the linear scan pattern of FIG. 10. A triangular scan pattern has a substantially piecewise linear scan profile in which several cycles of a linear scan (in both scan axes) are made to occur over the length of the scan. Each cycle includes two such consecutive linear scan segments whose slopes are the opposite of one another such that each cycle has left-right (mirror) symmetry about the mid-point of the cycle. In this example, there can be up to 1000 total scan points, between 2 and 500 triangular cycles per scan, and between 2 and 500 scan points per cycle. The distance between the scan points within a cycle along the secondary scan axis (the X-axis as shown in FIG. 16 and FIG. 17) at the surface of the test object 30 can be between 1.0 μm and 1.0 mm. Note that each of the cycles of the triangle scan profile illustrated in FIG. 17 appear to be somewhat arcuate and non-linear, as well as the envelope of the scan profile, which is caused solely by the cylindrical shape of the test object 30 and not by virtue of the scan mechanism scanning in a non-linear profile.

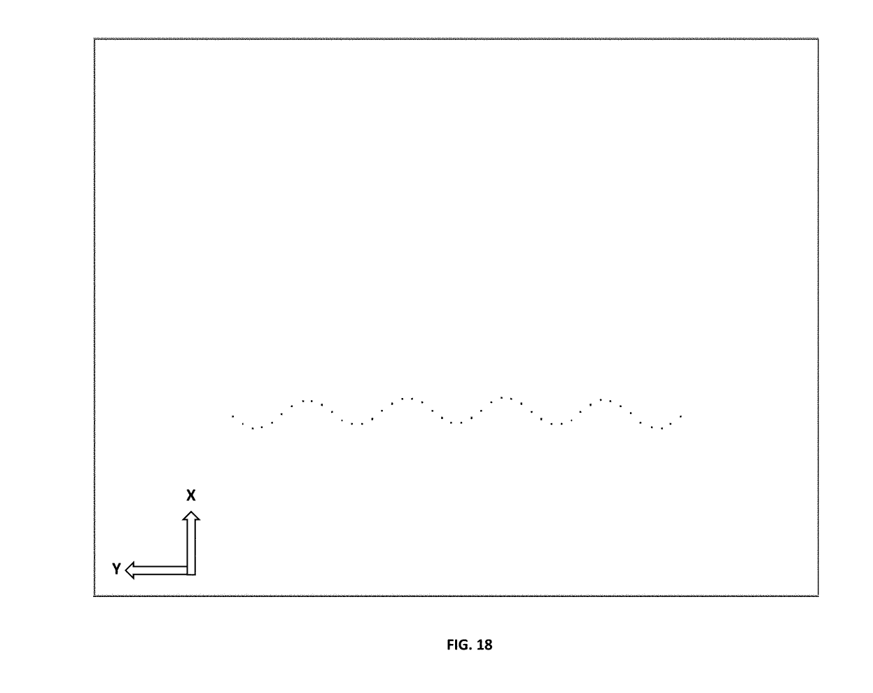

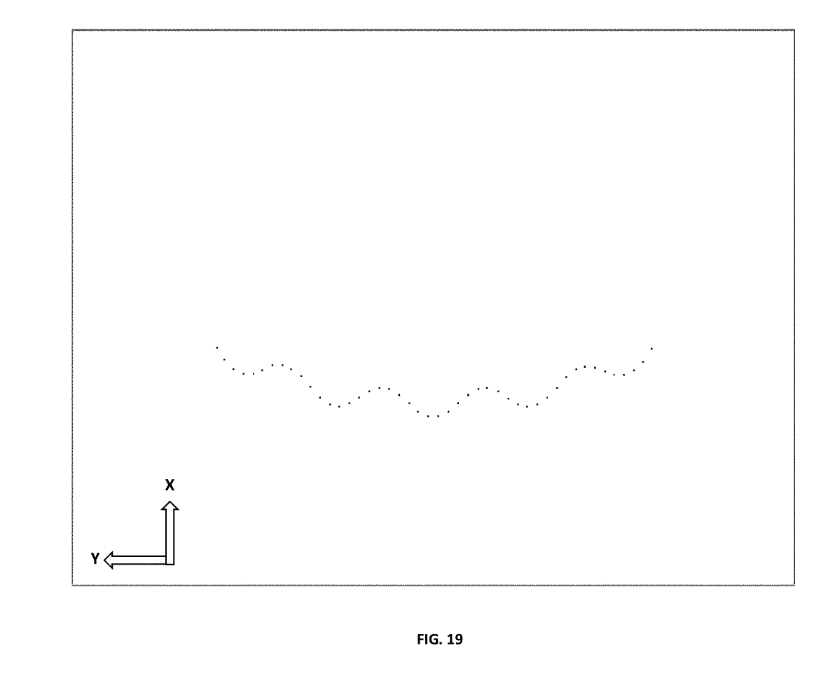

Yet another pattern that may be utilized for the present technology is a sinusoidal scan pattern as illustrated in FIG. 18 and FIG. 19. In FIG. 18, the sinusoidal scan pattern is executed across a planar test object 30, while in FIG. 19 the sinusoidal scan pattern is made across the same cylindrical test object 30 used in the linear scan pattern of FIG. 10. A sinusoidal scan pattern includes one or more cycles of a sinusoid over the length of the scan, but in this example there can be between 2 and 500 cycles/scan, up to 1000 total scan points, and between 2 and 500 scan points per cycle. The peak-to-peak distance within a cycle along the secondary scan axis (the X-axis as shown in FIG. 18 and FIG. 19) at the surface of the test object 30 can be between 5.0 μm and 5.0 mm. Note that the envelope of the sinusoid scan profile illustrated in FIG. 19 appears to be somewhat arcuate, which is caused solely by the cylindrical shape of the test object 30 and not by virtue of the scan mechanism scanning in an underlying non-sinusoidal profile.

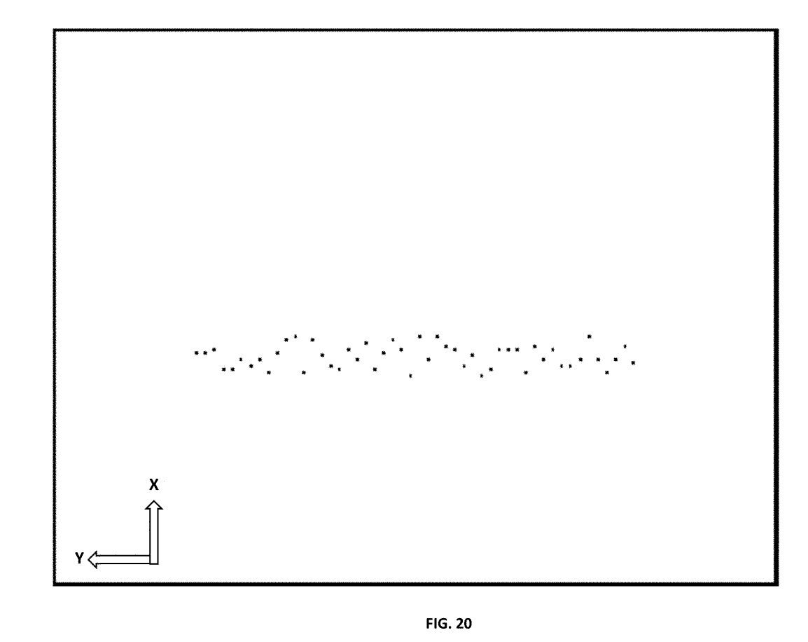

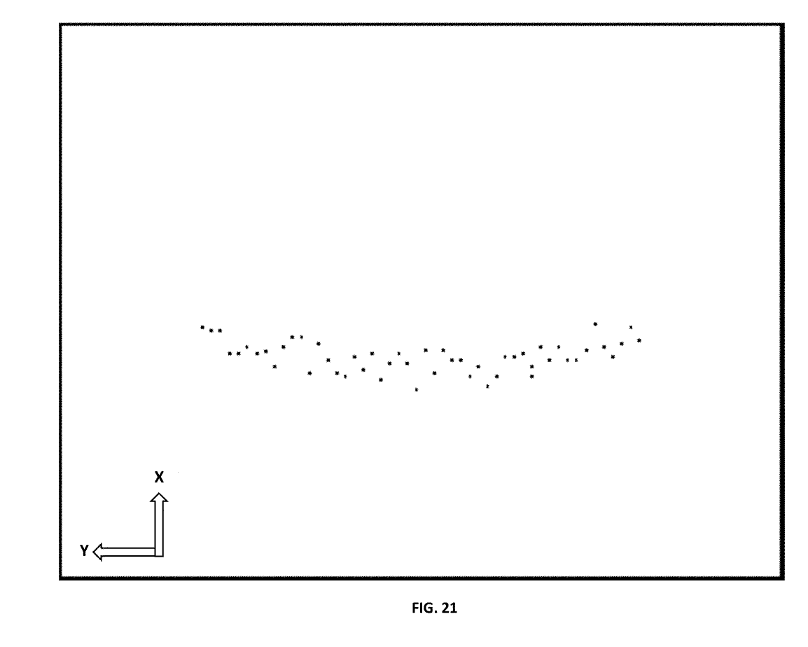

Still another pattern that may be employed in the present technology is a random scan pattern as illustrated in FIG. 20 and FIG. 21. In FIG. 20, the random scan pattern is executed across a planar test object 30, while in FIG. 21 the random scan pattern is made across the same cylindrical test object 30 used in the linear scan pattern of FIG. 10. A random scan pattern consists of pointwise scan locations whose spacing in the primary scan direction is substantially constant but whose location in the secondary scan direction can vary randomly from scan point to scan point, although the spacing in the primary scan direction vary and be non-uniform as well. In this example, there can be up to 1000 total scan points. The maximum to minimum range of the scan points along the secondary scan axis (the X-axis as shown in FIG. 20 and FIG. 21) at the surface of the test object 30 can be between 5.0 μm and 5.0 mm. The distribution of the random points in the secondary scan direction can have a Gaussian or uniform distribution. Furthermore, the random pattern can be non-repeating (i.e., truly random) or the random pattern can repeat after “M”, a certain number of scan points in which case the random pattern is pseudo-random. The number of scan points “M” per random segment of a pseudo-random pattern can be between ten and 500. Note that the envelope of the random scan profile illustrated in FIG. 21 appears to be arcuate, which is caused solely by the cylindrical shape of the test object 30 and not by virtue of the scanning mechanism scanning in an underlying arcuate profile.

Finally, scan profiles can be executed from combinations of the linear, sawtooth, square, triangular, sinusoidal, and random scan patterns described above. For example, depending upon the microstructure characteristics of the surface of the test object 30, it may be beneficial to scan in a pattern in which a random pattern is superimposed atop a triangle scan pattern to minimize the effects of the surface microstructure upon the surface measurement.

Accordingly, the present technology provides methods, non-transitory computer readable media, and scan management apparatuses that advantageously obtain surface profile scans of the surface of a test object that reduce the impact of surface texture on the scan profile results.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for reducing impact of surface texture in an optical scan of a surface of a test object implemented by a scan management apparatus, the method comprising:
providing instructions to an optical scanner device, configured to be capable of producing a localization element on the surface of the test object, to scan the localization element to a plurality of points across the surface of the test object in a two-dimensional scan pattern;
obtaining image data of an image of the localization element at each of the plurality of points along the surface of the test object; and
processing the obtained image data to determine a surface profile for the test object, wherein the two-dimensional scan pattern reduces surface texture errors in the surface profile.

2. The method as set forth in claim 1, wherein the two-dimensional scan pattern comprises a sawtooth pattern, a square pattern, a triangular pattern, a sinusoidal pattern, a pseudo-random pattern, a random pattern, or combinations thereof.

3. The method as set forth in claim 1, wherein the plurality of points comprises at least 3 points across the surface to the test object.

4. The method as set forth in claim 1, wherein the two-dimensional scan pattern comprises a plurality of cycles of a linear scan along a primary scan axis, wherein each of the points of the plurality of cycles of the linear scan are separated by a distance along a secondary scan axis.

5. The method as set forth in claim 4, wherein the plurality of cycles of the linear scan comprise between 2 and 500 cycles of the linear scan.

6. The method as set forth in claim 5, wherein each of the plurality of cycles of the linear scan comprises between 2 and 500 scan points.

7. The method as set forth in claim 4, wherein the two-dimensional pattern is a saw-tooth pattern or a triangular pattern and the distance along the secondary scan axis between each of the plurality of cycles of the linear scan is between about 1.0 micrometer to about 1.0 millimeter.

8. The method as set forth in claim 4, wherein the two-dimensional pattern is a square pattern and the distance along the secondary scan axis between each of the plurality of cycles of the linear scan is between about 5.0 micrometers to about 5.0 millimeters.

9. The method as set forth in claim 4, wherein the two-dimensional pattern is a sinusoidal pattern and a peak to trough distance along the second scan axis is between about 5.0 micrometers to about 5.0 millimeters.

10. The method as set forth in claim 4, wherein the two-dimensional pattern is a pseudo-random pattern or a random pattern and a maximum to minimum distance between the linear cycles along the second scan axis is between about 5.0 micrometers to about 5.0 millimeters.

11. The method as set forth in claim 1, wherein one or more two-dimensional scan patters are superimposed upon one another.

12. A scan management apparatus comprising memory comprising programmed instructions stored thereon and one or more processors configured to be capable of executing the stored programmed instructions to:
provide instructions to an optical scanner device, configured to be capable of producing a localization element on the surface of the test object, to scan the localization element to a plurality of points across the surface of the test object in a two-dimensional scan pattern;
obtain image data of an image of the localization element at each of the plurality of points along the surface of the test object; and
process the obtained image data to determine a surface profile for the test object, wherein the two-dimensional scan pattern reduces surface texture errors in the surface profile.

13. The apparatus as set forth in claim 12, wherein the two-dimensional scan pattern comprises a sawtooth pattern, a square pattern, a triangular pattern, a sinusoidal pattern, a pseudo-random pattern, a random pattern, or combinations thereof.

14. The apparatus as set forth in claim 12, wherein the plurality of points comprises at least 3 points across the surface to the test object.

15. The apparatus as set forth in claim 12, wherein the two-dimensional scan pattern comprises a plurality of cycles of a linear scan along a primary scan axis, wherein each of the plurality of cycles of the linear scan are separated by a distance along a secondary scan axis.

16. The apparatus as set forth in claim 15, wherein the plurality of cycles of the linear scan comprise between 2 and 500 cycles of the linear scan.

17. The apparatus as set forth in claim 16, wherein each of the plurality of cycles of the linear scan comprises between 2 and 500 scan points.

18. The apparatus as set forth in claim 15, wherein the two-dimensional pattern is a saw-tooth pattern or a triangular pattern and the distance along the secondary scan axis between each of the plurality of cycles of the linear scan is between about 1.0 micrometer to about 1.0 millimeter.

19. The apparatus as set forth in claim 15, wherein the two-dimensional pattern is a square pattern and the distance along the secondary scan axis between each of the plurality of cycles of the linear scan is between about 5.0 micrometers to about 5.0 millimeters.

20. The apparatus as set forth in claim 15, wherein the two-dimensional pattern is a sinusoidal pattern and a peak to trough distance along the second scan axis is between about 5.0 micrometers to about 5.0 millimeters.

21. The apparatus as set forth in claim 15, wherein the two-dimensional pattern is a pseudo-random pattern or a random pattern and a maximum to minimum distance between the linear cycles along the second scan axis is between about 5.0 micrometers to about 5.0 millimeters.

22. The apparatus as set forth in claim 12, wherein one or more two-dimensional scan patters are superimposed upon one another.

23. A non-transitory computer readable medium having stored thereon instructions for reducing impact of surface texture in an optical scan of a surface of a test object comprising executable code which when executed by one or more processors, causes the one or more processors to:
provide instructions to an optical scanner device, configured to be capable of producing a localization element on the surface of the test object, to scan the localization element to a plurality of points across the surface of the test object in a two-dimensional scan pattern;
obtain image data of an image of the localization element at each of the plurality of points along the surface of the test object;
process the obtained image data to determine a surface profile for the test object, wherein the two-dimensional scan pattern reduces surface texture errors in the surface profile.

24. The medium as set forth in claim 1, wherein the two-dimensional scan pattern comprises a sawtooth pattern, a square pattern, a triangular pattern, a sinusoidal pattern, a pseudo-random pattern, a random pattern, or combinations thereof.

25. The medium as set forth in claim 1, wherein the plurality of points comprises at least 3 points across the surface to the test object.

26. The medium as set forth in claim 1, wherein the two-dimensional scan pattern comprises a plurality of cycles of a linear scan along a primary scan axis, wherein each of the plurality of cycles of the linear scan are separated by a distance along a secondary scan axis.

27. The medium as set forth in claim 26, wherein the plurality of cycles of the linear scan comprise between 2 and 500 cycles of the linear scan.

28. The medium as set forth in claim 27, wherein each of the plurality of cycles of the linear scan comprises between 2 and 500 scan points.

29. The medium as set forth in claim 26, wherein the two-dimensional pattern is a saw-tooth pattern or a triangular pattern and the distance along the secondary scan axis between each of the plurality of cycles of the linear scan is between about 1.0 micrometer to about 1.0 millimeter.

30. The medium as set forth in claim 26, wherein the two-dimensional pattern is a square pattern and the distance along the secondary scan axis between each of the plurality of cycles of the linear scan is between about 5.0 micrometers to about 5.0 millimeters.

31. The medium as set forth in claim 26, wherein the two-dimensional pattern is a sinusoidal pattern and a peak to trough distance along the second scan axis is between about 5.0 micrometers to about 5.0 millimeters.

32. The medium as set forth in claim 26, wherein the two-dimensional pattern is a pseudo-random pattern or a random pattern and a maximum to minimum distance between the linear cycles along the second scan axis is between about 5.0 micrometers to about 5.0 millimeters.

33. The medium as set forth in claim 23, wherein one or more two-dimensional scan patters are superimposed upon one another.
